(19) United States
(12) Patent Application Publication
(10) Pub. No.: US 2023/0288266 A1
(43) Pub. Date: Sep. 14, 2023

(54) INFORMATION PROCESSING DEVICE, INFORMATION PROCESSING METHOD, AND PROGRAM

(71) Applicant: Premo R&D Inc., Chuo-ku (JP)

(72) Inventors: Hidenori TSUJI, Chuo-ku (JP); Junta MIYAMOTO, Chuo-ku (JP)

(21) Appl. No.: 18/183,076

(22) Filed: Mar. 13, 2023

(30) Foreign Application Priority Data
Jan. 13, 2022 (JP) 2022-003971

(51) Int. Cl. G01K 3/14

(52) U.S. Cl. CPC G01K 3/14

(57) ABSTRACT

Measurement of intended situation values. An information processing device, comprising: a processor having a memory; a sensing unit; an acquisition unit for acquiring, using the sensing unit, a measurement value corresponding to an situation in which the information processing apparatus is located; a logic storage unit for storing at least one of a plurality of calculation logics corresponding to a plurality of types of situation values indicating a state pertaining to the situation and a plurality of calculation logics corresponding to a plurality of types of calculation methods for the situation values; and a calculation unit for calculating the situation value from the measured value using the calculation logic corresponding to the set type of the situation value.

### TECHNICAL FIELDS

This invention relates to information processing devices, information processing methods, and programs.

### BACKGROUND ART

Patent literature 1 discloses a temperature sensing device that measures temperature.

### PRIOR ART LITERATURE

### Patent Literature

[PATENT LITERATURE 1] JP6342179B

### SUMMARY OF INVENTION

### Technical Problem

However, the temperature sensing devices described in Patent Literature 1 can only measure a single situation value, temperature. Or, it is not possible to change the method of measurement calculation in response to the situation.

In view of this background, the purpose of this invention is to provide a technique that can measure intended situation values or can measure situation value by an intended calculation method.

### Technical Solution

The principal invention to solve the above problem is an information processing device, comprising: a processor having a memory; a sensing unit; an acquisition unit for acquiring, using the sensing unit, a measured value corresponding to a situation in which the information processing apparatus is located; a logic storage unit for storing at least one of a plurality of calculation logics corresponding to a plurality of types of situation values indicating a state pertaining to the situation and a plurality of calculation logics corresponding to a plurality of types of calculation methods for the situation values; and a calculation unit for calculating the situation value from the measured value using the calculation logic corresponding to the set type of the situation value.

Other problems disclosed by this application and their solutions will be clarified in the “DETAILED DESCRIPTION OF THE EMBODIMENTS” section and in the drawings.

### Advantageous Effect

According to this invention, the intended situation values can be measured.

### BRIEF EXPLANATION OF DRAWINGS

FIG. 1 shows an example of the hardware configuration of a sensor device, which is an embodiment of the present invention.

FIG. 2 shows an example of software configuration of a sensor device, which is an embodiment of the present invention.

FIG. 3 shows an example of information stored in the logic storage unit 131 of an embodiment of the present invention.

FIG. 4 shows an example of information stored in the situation value storage unit 132, which is an embodiment of the present invention.

FIG. 5 shows an example of information stored in condition storage unit 133, which is an embodiment of the present invention.

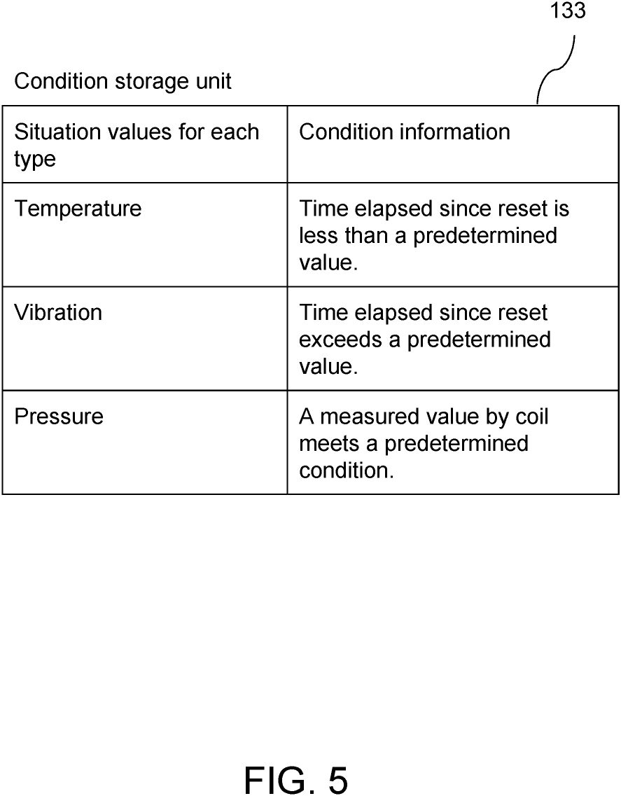

FIG. 6 illustrates the flow of processing, which is an embodiment of the present invention.

### DETAILED DESCRIPTION OF THE EMBODIMENTS

### Summary of Invention

The following is a list and description of the contents of the embodiments of the invention. The invention comprises, for example, the following.

### Item 1

An information processing device, comprising:
a processor having a memory;
a sensing unit;
an acquisition unit for acquiring, using the sensing unit, a measured value corresponding to the situation in which the information processing device is located;
a logic storage unit for storing at least one of a plurality of calculation logics corresponding to a plurality of types of situation values indicating a state pertaining to the situation and a plurality of calculation logics corresponding to a plurality of types of calculation methods for the situation values; and
a calculation unit for calculating the situation value from the measured value using the calculation logic corresponding to the set type.

### [Item 2]

The information processing device according to item 1, further comprising:

a transmission unit for transmitting the situation values to an external party via the sensing unit.

### [Item 3]

The information processing device as in item 1 or 2, further comprising:

a situation value storage unit for storing situation values for each type.

### [Item 4]

The information processing devices as in any one of items 1 to 3, further comprising:

a type receiving unit for receiving information specifying the type from outside via the sensing unit.

### [Item 5]

The information processing device as in any one of items 1 to 4, further comprising:

a registration unit for accepting input of the type and the calculation logic from the outside via the sensing unit and for writing the accepted type and the calculation logic into the storage unit.

### [Item 6]

The information processing device as in any one of items 1 to 5,

wherein the calculation unit calculates, from the measured value, the situation value of a first type using the first calculation logic and the situation value of a second type using the second calculation logic.

### [Item 7]

The information processing device as in any one of items 1 to 6, further comprising:
a condition storage unit for storing condition information of the calculation logic to be used for the calculation, and
wherein the calculation unit calculates the corresponding situation values according to the measurement logic that matches the condition information.

### [Item 8]

The information processing device as in any one of items 1 to 7, further comprising:
a situation value receiving unit for receiving the situation value of the first type transmitted by another information processing device, and
wherein the calculation unit calculates the situation value of the second type according to the calculation logic corresponding to the situation value of the second type, using the situation value of the first type calculated from the measured value by the first calculation logic corresponding to the first type and the situation value of the first type received from the other information processing device.

### [Item 9]

The information processing device as in any one of items 1 to 5,

wherein the calculation unit calculates the situation value based on the measured value by the first calculation logic corresponding to the first calculation method for calculating the situation value from an instantaneous value of the measured value, and by the second calculation logic corresponding to the second calculation method for calculating the situation value from time-series data of the measured value.

### [Item 10]

The information processing device as in any one of items 1 to 6, further comprising:
a condition storage unit for storing condition information of the calculation logic to be used for the calculation,
wherein the calculation unit calculates the situation values according to the corresponding calculation method according to the measurement logic that matches the condition information.

### [Item 11]

A method of information processing by an information processing device provided with a processor having a memory and a sensing unit, wherein the memory stores calculation logic corresponding to each of a plurality of types of situation values indicating the state pertaining to the situation in which the information processing device is located;
wherein the processor acquires a measured value, using the sensing unit, according to the situation in which the information processing device is located; and
wherein the situation value is calculated from the measured value by the calculation logic corresponding to the set type.

### [Item 12]

A program, in an information processing device comprising a processor having a memory storing calculation logic corresponding to each of a plurality of types of situation values; and a sensing unit, which executes at the processor:
a step of acquiring, using the sensing unit, measured values corresponding to the situation in which the information processing device is placed; and
a step of calculating the situation values from the measured values using the calculation logic corresponding to the set type.

### First Embodiment

### Hardware

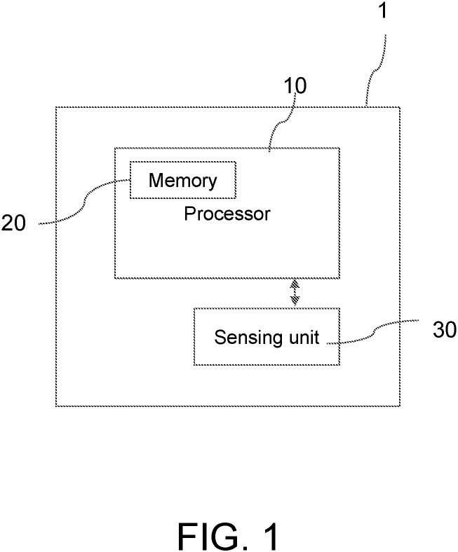

FIG. 1 shows an example of the hardware configuration of a sensor device. The sensor device 1 has a processor 10 and a sensing unit 30, and the processor 10 has a memory 20. The sensing unit 30 measures measurements according to the situation in which the sensor device is placed.

The processor 10 receives the measurement values measured by the sensing section 30, records them in the memory 20, and calculates situation values by feeding the measured values to the calculation logic. A situation value is a value that indicates the state of the situation in which the sensor device is placed. The processor 10 records the calculated situation values in the memory 20. In this embodiment, a coil 30 is applied as an example of a sensing unit, but it is not limited to this. The coil 30 can transmit and receive signals by inductive coupling with the coils 30 of other sensor devices that are placed adjacent to it. In this embodiment, sensor devices are used in pairs. As the relative distance or angle between the coils of the two sensor devices changes, the coupling strength of the inductive coupling changes, and the voltage value or amplitude value of the voltage generated in the coils changes. In this embodiment, the processor 10 can calculate the situation value using this voltage as the measured value. The memory 20 records the calculated situation value.

The sensor device of the present embodiment stores calculation logic for each of the multiple types of situation values, and can calculate multiple types of situation values from the same measured value. By using the calculation logic corresponding to a specified type, the sensor device can obtain different types of situation values based on the same sensor measurement value (voltage measured by the coil 30). The sensor device in this embodiment can be configured with a CPU by mounting the processor and sensing unit shown in Figure FIG. 1 on a semiconductor chip inseparably. In such a case, the diameter of the sensor device can be reduced to about 0.3 mm, for example, and the sensor device can be made smaller. For example, the processor and the sensing unit can be mounted on a semiconductor chip (on a single chip) inseparably. Here, a semiconductor chip is defined as a small thin piece of silicon (silicon die or die) with embedded electronic circuitry. Alternatively, in some cases, it can be defined as a package in which the silicon die is encapsulated.

### [Software]

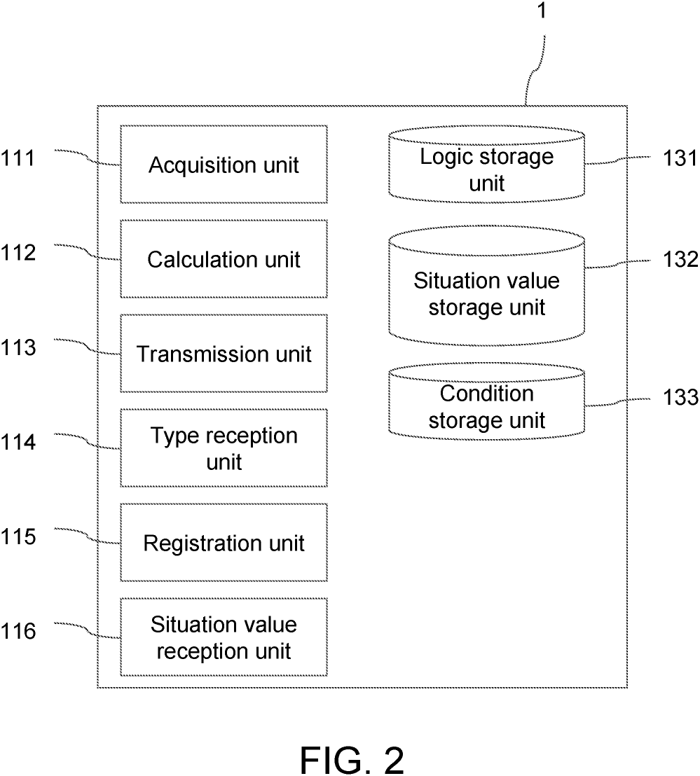

FIG. 2 is a block diagram showing the functional structure of the sensor device. As shown in FIG. 2, the sensor device consists of an acquisition unit 111, a calculation unit 112, a transmission unit 113, a type reception unit 114, a registration unit 115, a situation value reception unit 116, a logic storage unit 131, a situation value storage unit 132, and a condition storage unit 133.

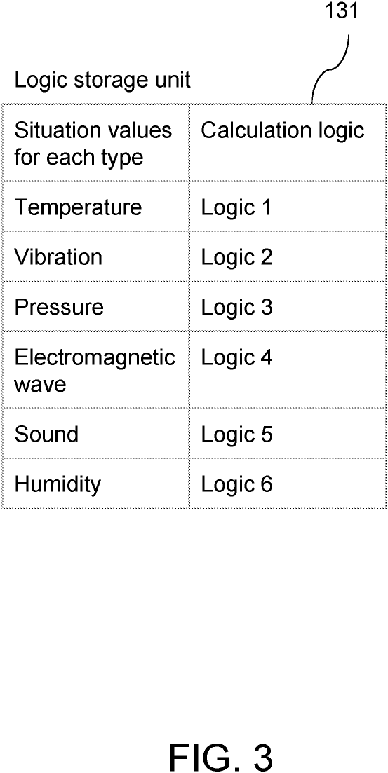

The logic storage unit 131 stores calculation logic. The logic storage unit 131 of this embodiment stores the calculation logic for each type of situation value. FIG. 3 shows an example of the information stored in the logic storage unit 131. The logic storage unit 131 stores calculation logic tied to the type of situation value. As described above, the calculation logic includes an algorithm for calculating an situation value based on a measurement value. The measurement value is the value measured by the coil, which in this embodiment can be, for example, the voltage value generated in the coil. The situation value is a value related to the situation in which the sensor device is located and can be, for example, temperature, vibration, pressure, electromagnetic waves, volume of sound, humidity, etc. For example, a change in the positional relationship between two sensor devices will change the voltage or amplitude of the voltage generated in the coil. It is also known that changes in the positional relationship between two sensor devices can be caused by temperature, pressure, humidity, etc. around the sensor devices, vibration such as sound or electromagnetic waves given from outside the sensor devices, vibration of objects in which the sensor devices are embedded, placed, or affixed, etc. By processing the coil voltage or voltage changes caused by these changes in the relative positional relationship of the sensor devices with appropriate calculation logic, for example, temperature, vibration, pressure, electromagnetic waves, volume of sound, humidity, etc. can be calculated.

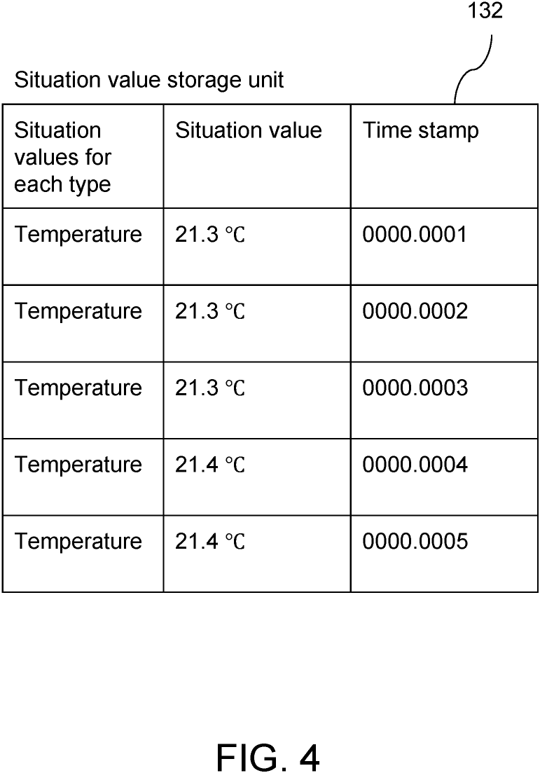

The situation value storage unit 132 stores situation values. The situation value storage unit 132 of this embodiment stores the history of situation values for each type. FIG. 4 shows an example of the information stored in the situation value storage unit 132. The situation value storage unit 132 includes, but is not limited to, information such as the type of situation value, the situation value, and the time when the value was calculated (time stamp). The time stamp may be the point in time when the measured value was measured.

The condition storage unit 133 stores information that determines which type of situation value is to be calculated. The condition storage unit 133 of this embodiment stores the type of situation value to be calculated when the condition is satisfied, in association with the condition for the event that can be obtained by the sensor device. A plurality of pairs of conditions and types of situation values may be registered. The condition storage unit 133 may store the type of situation value to be calculated without any conditions. The condition storage unit 133 may store one or more types of situation values to be calculated without any conditions.

The acquisition unit 111 acquires the measurement values measured by the sensing unit (coil) provided by the sensor device. The acquisition unit 111 in this embodiment can acquire the value of the voltage generated in the coil 30 as a measurement value.

The calculation unit 112 calculates situation values. The calculation unit 112 can calculate the situation value from the measured value using the calculation logic corresponding to the set type. For example, the calculation unit 112 can identify a type corresponding to a condition stored in the condition storage unit 133 that is satisfied, and read the calculation logic corresponding to the identified type from the logic storage unit 131, calculate the situation values by feeding the read-out calculation logic with the measured values acquired by the acquisition unit 111.

The calculation unit 112 can also calculate the first type of situation value from the measurements acquired from the coil 30 using the first calculation logic and the second type of situation value by a second calculation logic different from the first calculation logic. The calculation unit 112 calculates the first type of situation value from the measurements acquired from the coil 30 using the first calculation logic. At the same time, the calculation unit 112 can also calculate the second type of situation value by a second calculation logic different from the first calculation logic.

The calculation unit 112 can also calculate the corresponding situation values according to the measurement logic that meets the conditions. The calculation unit 112 determines, for example, whether the time information that can be acquired from the clock (not shown) and the measurement values acquired from the coil 30 satisfy the conditions stored in the condition storage unit 133. If there are conditions that are satisfied, the type corresponding to the satisfied conditions can be identified, the calculation logic corresponding to the identified type can be read from the logic storage unit 131, and the calculation logic read can be used to calculate the situation values.

The calculation unit 112 can also calculate the first type of situation value calculated from the measured values according to the first calculation logic corresponding to the first type and the second type of situation value calculated according to the calculation logic corresponding to the second type of situation value using the first type of situation value received from the other sensor device. For example, the calculation unit 112 can calculate the temperature (first type of situation value) and humidity (second type of situation value) from the measured values and calculate the discomfort index using the temperature and humidity.

The transmission unit 113 transmits the situation values externally. The transmission unit 113 can transmit the situation values externally via the coil 30. In this case, the coil 30 functions as an acquisition unit to acquire measurements and a transmission unit to transmit the situation values to the outside. The transmission unit 113 can also transmit the situation values by other means.

The type reception unit 114 accepts the specification of the type of situation values. The type reception unit 114 can receive information specifying the type from an external device via the coil 30, for example. The type of situation value can include, for example, temperature, vibration, pressure, electromagnetic waves, volume of sound, humidity, etc.

The registration unit 115 registers the calculation logic. The registration unit 115 can, for example, receive input of the type and calculation logic from an external device via the coil 30 and write the received type and calculation logic into the logic storage unit 131. The situation value reception unit 116 can receive situation values transmitted from other sensor devices.

The calculation unit 112 can be configured to calculate a third situation value using the first situation value received by the situation value reception unit 116 and the second situation value calculated by the calculation logic. For example, if the sensor device is located underground, the calculation unit 112 can receive the temperature from the sensor device located on the ground surface and calculate the temperature difference between the ground surface and underground calculated by itself by comparing the temperatures.

### [Behavior]

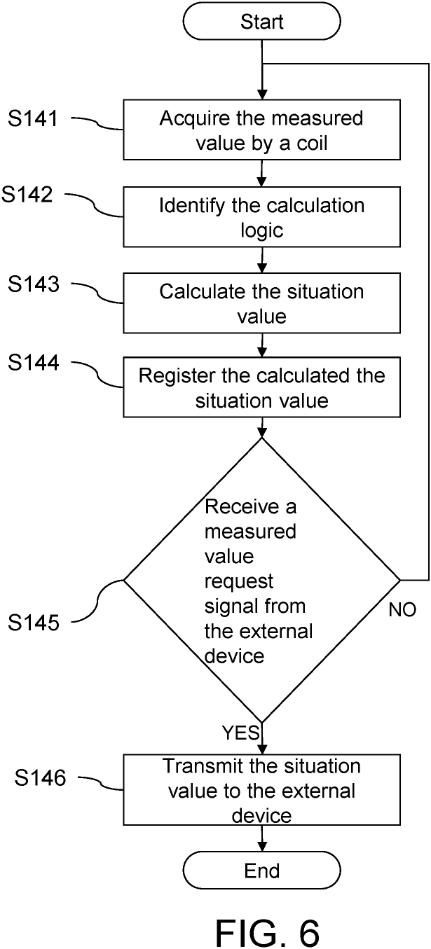

FIG. 6 is a control flow diagram illustrating the process of one embodiment of this invention.

In the sensor device, the acquisition unit 111 acquires the measured value (in this embodiment, the voltage of the coil 30) measured by the sensor (S141). Next, the calculation unit 112 identifies the type of situation value corresponding to the condition stored in the condition storage unit 133 that has been fulfilled (or identifies the type based on information specifying the type of situation value reception unit received from the outside via the coil), then identifies the calculation logic corresponding to the identified type from the logic storage unit 131 (S142), calculates the situation value by giving the measured value to the identified calculation logic (S143), and registers the calculated situation value with the type of situation value and a time stamp in the situation value storage unit 132 (S144).

When the transmission unit 113 receives a measured value request signal from the external device (S145:YES), it transmits the situation value registered in the situation value storage unit 132 to the external device (S146). Here, the transmission unit 113 may transmit the latest situation value, or it may transmit a history of some or all of the situation values.

### Second Embodiment

In this embodiment, the calculation logic corresponding to each type of situation value including, for example, temperature, vibration, pressure, electromagnetic waves, volume of sound, humidity, etc., is stored in the logic storage unit, and the calculation logic corresponding to the specified type is used to calculate an situation value from the measured value(s). However, the invention is not limited to this, and can be applied to cases where the same type of situation value is calculated using different calculation methods (calculation logic).

As an example of calculating the same type of situation value using different calculation methods, for example, when calculating an situation value using the voltage value generated in a coil as the measured value, a first calculation method that calculates the situation value based on an instantaneous value of the voltage value, a second calculation method that calculates the situation value based on a time series of voltage values (for example, 10 seconds), futhermore, a third calculation method, which calculates the situation value based on a time series of values that is even longer than the time series values used in the second calculation logic (e.g., 10 minutes), can be considered. In this embodiment, the calculation logic corresponding to each of these first to three calculation methods can be stored in the logic storage unit to enable the calculation of situation values by switching the calculation logic as appropriate.

In this embodiment, when the same type of situation value can be calculated using different calculation methods, for example, the calculation can be performed using the calculation logic corresponding to the third calculation method, which calculates situation values based on time series values over a longer period of time (e.g., 10 minutes) to improve the accuracy of the measurement of situation values. Conversely, the calculation can be performed using the calculation logic corresponding to the first or second calculation method, which calculates situation values based on time-series values or instantaneous values over a shorter period of time, in order to reduce the calculation load for the measurement of the situation values.

In the second embodiment, the same technology as in the first embodiment shall be applicable to the hardware configuration, etc. in the method of switching the calculation logic except for the points mentioned above.

This embodiment is described above to facilitate understanding of the invention and is not intended to limit or interpret the invention. The invention may be changed and improved without departing from its intent, and the invention also includes equivalents thereof.

### DESCRIPTION OF REFERENCE NUMERALS

1 Sensor device
10 Processor
20 Memory
30 Sensing unit
111 Acquisition unit
112 Calculation unit
113 Transmission unit
114 Type reception unit
115 Registration unit
116 Situation value reception unit
131 Logic storage unit
132 Situation value storage unit
133 Condition storage unit

1. An information processing device, comprising:
a processor having a memory;
a sensing unit;
an acquisition unit for acquiring, using the sensing unit, a measured value corresponding to a situation in which the information processing device is located;
a logic storage unit for storing at least one of a plurality of calculation logics corresponding to a plurality of types of situation values indicating a state pertaining to the situation and a plurality of calculation logics corresponding to a plurality of types of calculation methods for the situation values; and
a calculation unit for calculating the situation value from the measured value using the calculation logic corresponding to the set type.

2. The information processing device according to claim 1, further comprising:
a transmission unit for transmitting the situation values to an external party via the sensing unit.

3. The information processing device according to claim 1, further comprising:
a situation value storage unit for storing situation values for each type.

4. The information processing devices according to claim 1, further comprising:
a type receiving unit for receiving information specifying the type from outside via the sensing unit.

5. The information processing device according to claim 1, further comprising:
a registration unit for accepting input of the type and the calculation logic from the outside via the sensing unit and for writing the accepted type and the calculation logic into the storage unit.

6. The information processing device according to claim 1,
wherein the calculation unit calculates, from the measured value, the situation value of a first type using the first calculation logic and the situation value of a second type using the second calculation logic.

7. The information processing device according to claim 1, further comprising:
a condition storage unit for storing condition information of the calculation logic to be used for the calculation, and
wherein the calculation unit calculates the corresponding situation values according to the measurement logic that matches the condition information.

8. The information processing device according to claim 1, further comprising:
a situation value receiving unit for receiving the situation value of the first type transmitted by another information processing device, and
wherein the calculation unit calculates the situation value of the second type according to the calculation logic corresponding to the situation value of the second type, using the situation value of the first type calculated from the measured value by the first calculation logic corresponding to the first type and the situation value of the first type received from the other information processing device.

9. The information processing device according to claim 1,
wherein the calculation unit calculates the situation value based on the measured value by the first calculation logic corresponding to the first calculation method for calculating the situation value from an instantaneous value of the measured value, and by the second calculation logic corresponding to the second calculation method for calculating the situation value from time-series data of the measured value.

10. The information processing device according to claim 1, further comprising:
a condition storage unit for storing condition information of the calculation logic to be used for the calculation,
wherein the calculation unit calculates the situation values according to the corresponding calculation method according to the measurement logic that matches the condition information.

11. A measurement method by an information processing device provided with a processor having a memory and a sensing unit,
wherein the memory stores at least one of a plurality of calculation logics corresponding to each of the plurality of types of situation values indicating the state pertaining to a situation in which the information processing device is located and a plurality of calculation logics corresponding to each of the plurality of types of calculation methods for the situation value,
the method executed by the processor comprising:
acquiring a measured value, using the sensing unit, according to the situation in which the information processing device is located; and
calculating the situation value from the measured value using the calculation logic corresponding to the set type.

12. A non-transitory computer-readable medium storing program for causing a processor, in an information processing device comprising the processor having a memory storing at least one of a plurality of calculation logics corresponding to each of a plurality of types of situation values and a plurality of calculation logics corresponding to each of a plurality of types of calculation methods for the situation values; and a sensing unit, to execute processing comprising:
acquiring, using the sensing unit, measured values corresponding to the situation in which the information processing device is placed; and
calculating the situation values from the measured values using the calculation logic corresponding to the set type.
